(19) United States
(12) Patent Application Publication
(10) Pub. No.: US 2011/0127280 A1
(43) Pub. Date: Jun. 2, 2011

(54) CONTAINER WITH SLEEVE

(76) Inventors: John M. Lown, Huntington Beach, CA (US); Richard Jung, Irvine, CA (US)

(21) Appl. No.: 12/629,266

(22) Filed: Dec. 2, 2009

(51) Int. Cl. B65D 90/00; B23P 11/02

(52) U.S. Cl. 220/694; 29/450

(57) ABSTRACT

A container assembly is provided including a container body; and a sleeve body. The sleeve body defines an open space within the sleeve body, and a first opening formed at a first end of the sleeve body concentric about a central axis of the sleeve body. The sleeve body also defines a second opening disposed on a surface of the sleeve body substantially perpendicular to the first opening. The second opening provides access to the open space, and includes an edge perimeter that provides increased elasticity to the second opening relative to the remainder of the sleeve body.

### BACKGROUND

The invention relates to a container used for the storing, transporting and accessing of substances.

Glass containers are being used in place of plastic containers to avoid the possibility of contamination of contents from chemical elements found in typical plastic containers that may leach into the contents held in the containers.

However, the use of glass containers alone presents a problem in that glass containers are perceived to be relatively fragile and thus susceptible to breakage. It is very often for this reason that glass containers are not viewed as favorably as plastic containers for the storage, transport, and access of fluids.

### SUMMARY

In one aspect, a container assembly is provided including a container body; and a sleeve defining a first opening formed at a first end of the sleeve concentric about a central axis of the sleeve. The sleeve also defines a second opening formed on a surface of the sleeve substantially parallel to the central axis. The second opening is configured to operate between a first condition, where the second opening has a first dimension and a second condition where the second opening has a second dimension for receiving the container body therethrough.

In another aspect, a container assembly is provided including a container body; and a sleeve body made of a sleeve body material. The sleeve body defines an open space within the sleeve body, and a first opening formed at a first end of the sleeve body concentric about a central axis of the sleeve body. The sleeve body also defines a second opening disposed on a surface of the sleeve body substantially perpendicular to the first opening. The second opening provides access to the open space, and includes an edge perimeter that provides increased elasticity to the second opening relative to the remainder of the sleeve body. The second opening is stretchable from a first condition in which the second opening is un-stretched to a second condition in which at least a portion of the edge perimeter is stretched to a receiving dimension configured to have the container body inserted therethrough. When the second opening is in the second condition the edge perimeter is not stretched beyond the elastic capacity of the sleeve body material. The second opening is also configured to return to the first condition after having achieved the receiving dimension.

In another aspect, a method for the assembly of a container is provided which includes providing a container body and a sleeve body, the sleeve body having an aperture formed on a surface of the sleeve body that is parallel to a central axis of the sleeve body and perpendicular to an opening defined concentrically with the central axis; stretching the aperture from a first dimension to a second dimension, the second dimension configured to receive the container body therethrough without exceeding the elastic capability of a sleeve body material; and returning the aperture from the second dimension to the first dimension once the container body is received within the sleeve body through the aperture.

This brief summary has been provided so that the nature of this disclosure may be understood quickly. A more complete understanding of the disclosure can be obtained by reference to the following detailed description of the various embodiments thereof in connection with the attached drawings.

### BRIEF DESCRIPTION OF THE DRAWINGS

The foregoing features and other features of the present disclosure will now be described with reference to the drawings of an illustrated embodiment. In the drawings, the same components have the same reference numerals. The illustrated embodiment is intended to illustrate, but not to limit the disclosure. The drawings include the following Figures:

FIG. 1A is a perspective illustration of a container having a container body with a sleeve disposed thereon in accordance with an embodiment;

FIG. 1B is an exploded view of the container of FIG. 1A in accordance with an embodiment;

FIGS. 2A and 2B are sectional views of an aperture formed on the surface of the sleeve body in accordance with an embodiment;

FIG. 3 is an illustration of a cap assembly for use with the container body in accordance with an embodiment;

FIG. 4 is a perspective illustration of a container having a container body with a sleeve disposed thereon in accordance with an embodiment; and

FIG. 5 is a flowchart showing a process for assembling a container having a container body and sleeve in accordance with an embodiment.

### DETAILED DESCRIPTION

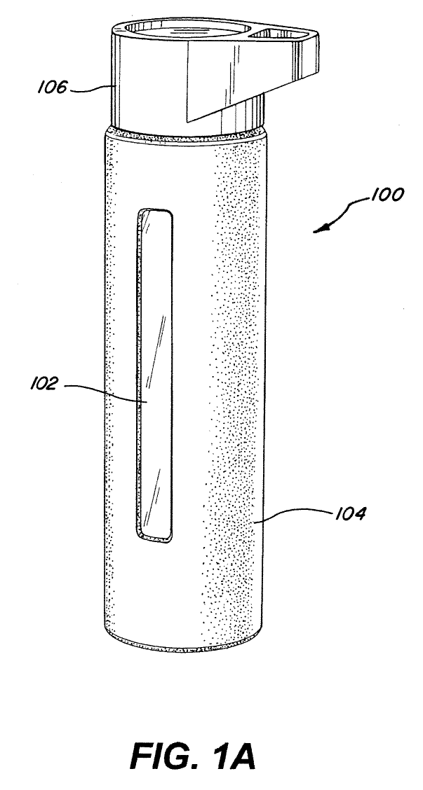

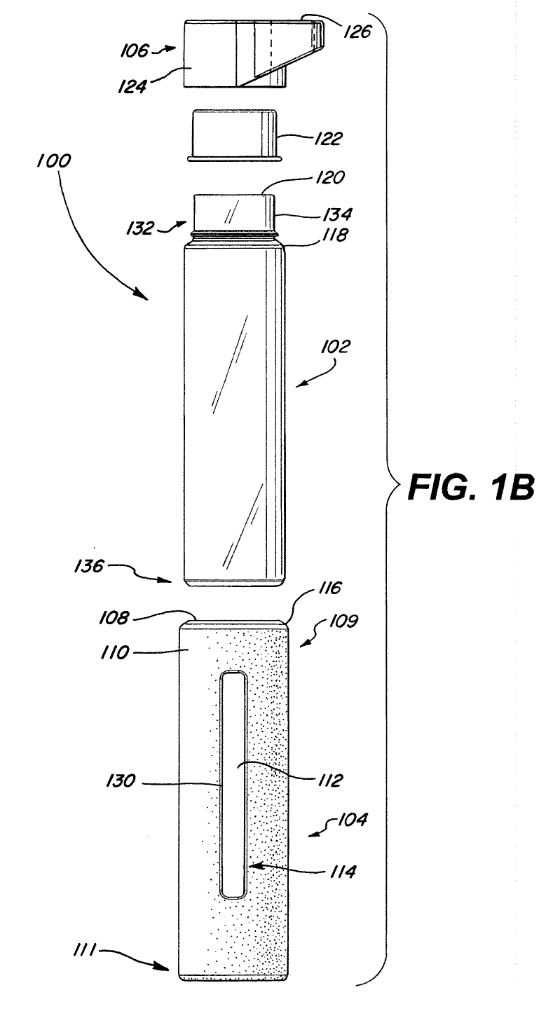

FIG. 1A is a perspective illustration of a container assembly 100 including a container body 102 with a sleeve 104 disposed thereon, and a cap assembly 106 used to secure the contents within the container body 102.

Referring now to FIGS. 1A and 1B, in certain embodiments, the container body 102 may be used to hold a liquid, gas or solid substances. In the description that follows, without any intent to be limiting thereto, the container body 102 is described for use primarily with a liquid.

In accordance with an embodiment, the container body 102 may be made of a glass, a plastic, a metal or metal alloy, and the like. The glass container body, for example, may be made of any suitable type of glass, such as silicon dioxide, Pyrex, lead crystal and the like. The metal container body, for example, may be made of any suitable type of metal, such as aluminum, stainless steel, suitable alloys of any suitable metals and the like.

The container body 102 may be designed to any desired volume. For example, the container body 102 may be designed to hold from about 4 ounces to about 64 ounces.

In some embodiments, the sleeve 104 provides a level of protection from harm to the container body 102 from shock leading to breakage or from the elements, such as heat, cold, light and the like. In some embodiments, the sleeve 104 may have formed thereon indentations, grooves, ribbing or any similar raised surface elements which may aid in the ability to grip the container assembly 100.

As shown in FIG. 1B, the sleeve 104 includes an opening 108 defined at a first end 109 of a sleeve body 110. The sleeve body 110 defines a hollow lumen or open space 112 within the sleeve body 110, which is sized and shaped to receive the container body 102 therein. In some embodiments, the opening 108 at the first end 109 may be further defined by a lip portion 116 extending into the opening 108 at an angle to the central axis of the sleeve body 110. In one embodiment, the lip portion 116 may be configured to contact with a shoulder portion 118 formed on the container body 102 for retaining the container body 102 that is inserted or otherwise held within the sleeve body 110.

In one alternative embodiment, a second end 111 of the sleeve body 110 may include a second opening (not shown) or may be closed. A second lip portion (not shown) may be used to further define the second opening and may be configured to contact and fit over an edge formed on the closed end of the container body 102 for retaining the container body 102 that is inserted or otherwise held within the sleeve body 110.

The sleeve body 110 also has at least one aperture or open slot 114 defined on a surface of the sleeve body 110 providing and allowing access through the sleeve body 110 to the hollow space 112. In some embodiments, the sleeve body 110 may include from one to a plurality of apertures 114 disposed circumferentially around the sleeve body 110.

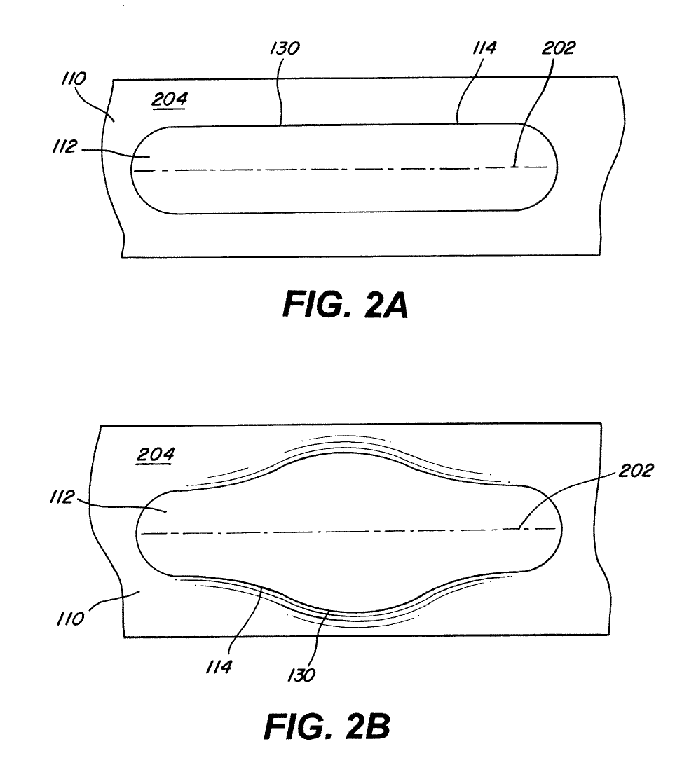

FIGS. 2A and 2B are sectional views of the sleeve body 110 showing the aperture 114 in accordance with an embodiment. As shown in FIG. 2A, the aperture 114 may have a generally elongated oval shape. In a first condition the aperture 114 is in an un-opened or un-stretched condition. As shown in FIG. 2B, in a second condition the aperture 114 is shown in an opened or stretched condition. In one embodiment, the aperture 114 is configured to allow the container body 102 to be inserted and passed through the aperture 114 so as to be thereafter contained within the protective sleeve. The aperture 114 is configured to be opened to a size that allows the container body 102 to be inserted into the aperture 114 for assembly of the container assembly 100.

In one embodiment, an edge perimeter 130 (FIG. 1B) of the aperture 114 may be made to have a thickness that may be thinner or thicker than the remainder of the sleeve body 110. In such an embodiment, the thickness of the edge perimeter 130 may provide an added elasticity to the aperture 114. This allows the aperture 114 to be placed in the second condition where the aperture 114 is opened or stretched as shown in FIG. 2B when appropriately manipulated either manually or by machine. The edge perimeter 130, however, includes enough material memory to cause the aperture 114 to return to the first condition where the aperture 114 is un-stretched (FIG. 2A). To allow the container body 102 to be inserted through the aperture 114, the aperture is dimensioned in the first condition to a size, which depending on the size and shape of the underlying container body 102, provides a suitable entry point when adequately stretched or opened as in the second condition. Moreover, the aperture 114 is dimensioned such that the stretching or opening of the aperture 114 during insertion of the container body 102 does not cause the material of the edge perimeter 130 or the material of the remainder of the sleeve body 110 to become broken, ripped, torn, stretched beyond the elastic capacity of the material or any other similarly detrimental occurrence. Accordingly, in certain embodiments, the sleeve body 110 may be made of a suitable elastic material, such as a silicone material or a silicone containing material.

Referring again to FIGS. 1A and 1B, the container body 102 includes an opening 120 configured for receiving and retaining the cap assembly 106. In one embodiment, cap assembly 106 includes a cap inner member 122, a cap outer member 124 and a hook or loop member 126 integrally formed with the cap outer member 124. The loop member 126 is generally formed to extend out away from the central axis of the container body 102, such that the loop member 126 provides a means for holding the container assembly 100, either by hand or by using some other means, such as a string or belt and the like. The cap assembly 106 is configured for being removably associated with the container body 102, using any type of securing element well known in the art. For example, the cap assembly 106 may be screwed onto threads formed adjacent the opening 120 on the container body 102 or the cap assembly 106 may be made to “snap” on to the container body 102.

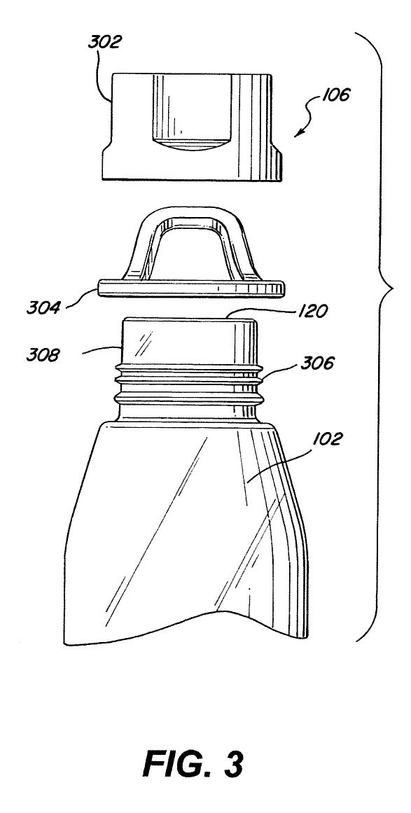

An alternative cap assembly 106 is shown in FIG. 3 having a cap member 302 and a loop member 304, where the loop member 304 is a separate element from the cap member 302. The loop member 304 is placed about the opening 120 of container body 102 and positioned below a set of threads 306 formed on a neck 308 of the opening 120. Once the loop member 304 is in position, the cap member 302 may be threaded onto the threads 306 and over the loop member 304, thus securing both the cap member and the loop member onto the container body 102.

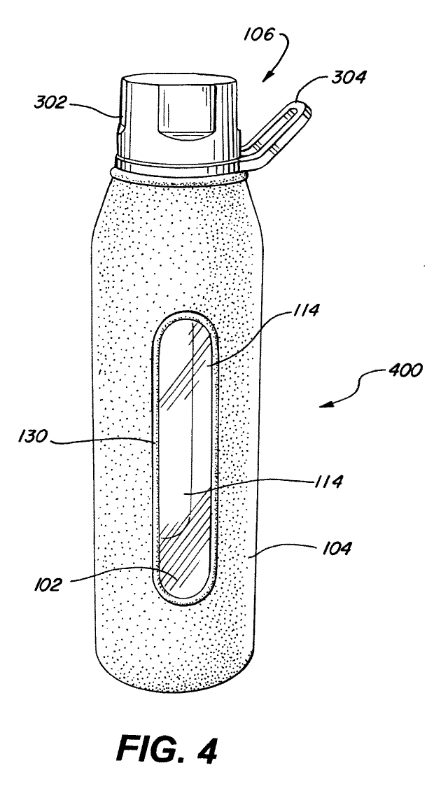

FIG. 4 is a perspective view of another embodiment of a container 400 including a container body 102 with a sleeve 104 disposed thereon, and a cap assembly 106 including cap member 302 and loop member 304 (FIG. 3) used to secure the contents within the container body 402. The container 400 is an exemplary illustration of the potential for variability of both the shapes and contours that are encompassed within the scope of the container body and sleeve disclosed herein.

Operationally, the sleeve 104 is configured to be fit onto and around the container body 102 in a tight snug fit. The tight snug fit causes the sleeve body 110 to be held to the container body 102 with such a force that the friction between an internal surface of the sleeve body 110 and an outer surface of the container body 102 keeps the container body 102 from moving relative to the sleeve body 110 when the container body 110 is disposed in the open space 112.

In some embodiments, an opening is provided concentric with the central axis of the sleeve body 110, such as opening 108. The opening may be configured and sized such that the container body may not be able to pass through the opening. To maintain the desired amount of tightness or “snugness” between the container body 102 and the sleeve body 110, in accordance with an embodiment, the diameter of the opening 108 may not be made stretchable enough to accommodate the insertion of the container body 102. For example, the opening 108 may be configured to tightly fit and/or conform to a neck portion of the container body 102 that has a smaller diameter than the remainder of the container body 102. The sleeve body 110 may also be contoured or tapered to follow the shape of the container body 102 and thus, there may be portions of the sleeve body along its length that have a smaller diameter than the container body 102. To ensure the proper snugness, the sleeve body may not be made stretchable enough to accommodate the insertion of the container body 102.

In some embodiments, when inserting the container body 102 through an opening disposed concentrically at an end of the sleeve body 110, such as opening 108, the friction created between the surface of the container body 102 and the internal surface of the sleeve body 110 as the container body is forced into the sleeve body becomes prohibitive to the proper assembly of the container assembly 100.

In the embodiments described herein, the sleeve body 110 includes at least one aperture 114 in addition to a concentrically positioned opening 108, for example, as shown in FIG. 1B. The aperture 114 provides a means for inserting container body 102 into the space 112 defined by the sleeve body 110 without the need to insert the container body 102 through the opening 108.

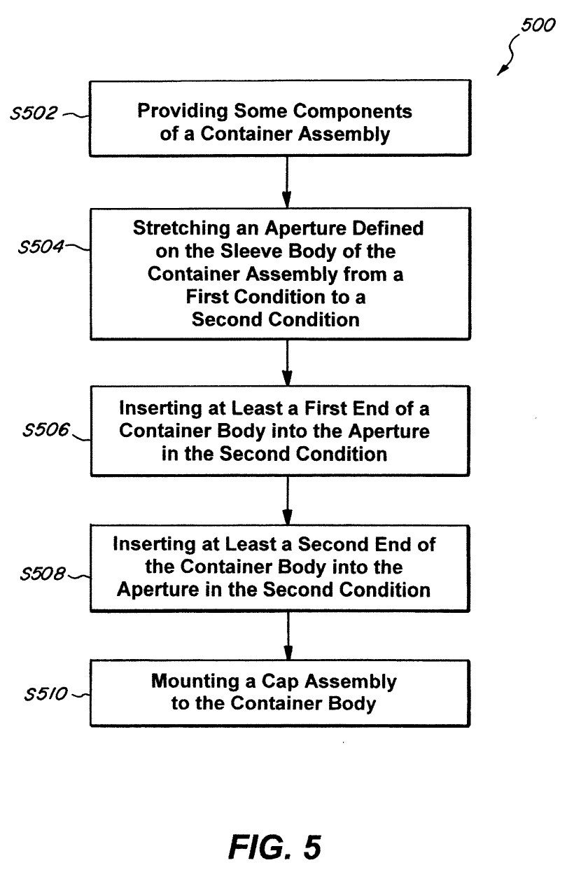

FIG. 5 shows a flow diagram that describes the assembly process 500 for the container assembly 100 in accordance with an embodiment. The following steps are described with reference to FIGS. 1B, 2A, 2B and 5. In step s502, at least some components of container assembly 100 are provided which includes at least a container body 102 and a sleeve 104.

As previously described, at least one aperture 114 is formed on a surface 204 of the sleeve body 110 aligned substantially parallel to the central axis 202 of the sleeve body 110. In step s504, the edge perimeter 130 of the aperture 114 is stretched from a first condition, where the edge perimeter is not stretched to a second condition where the edge perimeter is stretched to form an enlarged opening. The enlarged opening may be stretched to a size and shaped configured to receive the container body 102, without causing any permanent detrimental consequences to the edge perimeter 130 or any part of the sleeve surface 204, such as tearing, ripping, breaking, stretching beyond the elastic capacity of the material and the like.

In step s506, a first end of the container body 102 is inserted into the enlarged opening. For example, in one embodiment, a top end 132 of the container body 102 is inserted through the enlarged opening at an angle to the central axis 202. The container body 102 is pushed upward into the sleeve body 110 until a neck portion 134 of the container body 102 extends through the opening 108 from within the sleeve body 110. The shoulder portion 118 contacts with an internal surface of the lip portion 116 formed on the sleeve body 110 for retaining the container body 102. Although, the top end 132 may be within the sleeve body 110, the remainder of the container body 102 adjacent the bottom end 136 may be still positioned outside of the aperture 114.

In step s508, a second end of the container body 102 is inserted into the enlarged opening. For example, in one embodiment, a bottom end 136 of the container body is inserted into the stretched aperture 114. The bottom end 126 is forced into the aperture 114 causing the sleeve body 110 to be wrapped around the bottom end 136 of the container body 102. Once the container body is completely inserted into space 112 of the sleeve body 110, the edge perimeter 130 returns to the first condition so that the sleeve body contains the container body with the appropriate tightness.

Thereafter, in step s510, as desired, the cap assembly 106 may be mounted to the container neck 134 to close the container body.

Although the present disclosure has been described with reference to specific embodiments, these embodiments are illustrative only and not limiting. Many other applications and embodiments of the present disclosure will be apparent in light of this disclosure and the following claims.

What is claimed is:

1. A container assembly comprising:
a container body; and
a sleeve defining a first opening formed at a first end of the sleeve concentric about a central axis of the sleeve, and a second opening formed on a surface of the sleeve substantially parallel to the central axis, the second opening configured to operate between a first condition where the second opening has a first dimension and a second condition where the second opening has a second dimension for receiving the container body therethrough.

2. The container assembly of claim 1, further comprising a cap assembly for mounting to the container body to enclose the container body.

3. The container assembly of claim 2, wherein the cap assembly comprises a cap and a loop member.

4. The container assembly of claim 1, wherein the sleeve comprises silicone or materials including silicone.

5. The container assembly of claim 1, wherein the sleeve comprises a lip portion configured to contact a shoulder portion formed on the container body.

6. The container assembly of claim 1, wherein the sleeve comprises one or more griping elements.

7. The container assembly of claim 1, wherein the second opening comprises an elongated oval shape having an edge perimeter that provides increased elasticity to the second opening.

8. The container assembly of claim 1, wherein the first dimension comprises an un-stretched dimension and the second dimension comprises a stretched condition.

9. The container assembly of claim 8, wherein the second opening is configured to return to the first dimension after having achieved the second dimension.

10. The container assembly of claim 1, wherein the second opening comprises a plurality of openings distributed on the surface of the sleeve substantially parallel to the central axis.

11. The container assembly of claim 1, wherein when the second opening operates in the second condition the sleeve is not stretched beyond the elastic capacity of a sleeve material.

12. A container assembly comprising:
a container body; and
a sleeve body made of a sleeve body material defining an open space within the sleeve body, and a first opening formed at a first end of the sleeve body concentric about a central axis of the sleeve body, and a second opening disposed on a surface of the sleeve body substantially perpendicular to the first opening and providing access to the open space, the second opening including an edge perimeter that provides increased elasticity to the second opening relative to the remainder of the sleeve body and that is stretchable from a first condition in which the second opening is un-stretched to a second condition in which at least a portion of the edge perimeter is stretched to a receiving dimension configured to have the container body inserted therethrough, when the second opening is in the second condition the edge perimeter is not stretched beyond the elastic capacity of the sleeve body material and the second opening is configured to return to the first condition after having achieved the receiving dimension.

13. The container assembly of claim 12, further comprising a cap assembly for mounting to the container body to enclose the container body.

14. The container assembly of claim 13, wherein the cap assembly comprises a cap and a loop member.

15. The container assembly of claim 12, wherein the sleeve body comprises silicone or materials including silicone.

16. The container assembly of claim 12, wherein the sleeve body comprises a lip portion configured to contact a shoulder portion formed on the container body once at least a portion of the container body is inserted through the second opening.

17. The container assembly of claim 16, wherein the lip portion is tapered toward the central axis to a diameter less than the diameter of the container body.

18. A method for the assembly of a container assembly comprising:
providing a container body and a sleeve body, the sleeve body having an aperture formed on a surface of the sleeve body that is parallel to a central axis of the sleeve body and perpendicular to an opening defined concentrically with the central axis;
stretching the aperture from a first dimension to a second dimension, the second dimension configured to receive the container body therethrough without exceeding the elastic capability of a sleeve body material; and
returning the aperture from the second dimension to the first dimension once the container body is received within the sleeve body through the aperture.

19. The method of claim 18, further comprising sealing the container body with a cap assembly.

20. The method of claim 18, wherein the sleeve body material comprises a silicone or silicone containing materials.
